(19) United States
(12) Patent Application Publication
(10) Pub. No.: US 2008/0304421 A1
(43) Pub. Date: Dec. 11, 2008

(54) Internet Latencies Through Prediction Trees

(75) Inventors: Venugopalan Saraswati Ramasubramanian, Mountain View, CA (US); Dahlia Malkhi, Palo Alto, CA (US); Mahesh Balakrishnan, Ithaca, NY (US); Fabian Daniel Kuhn, Therwil (CH); Ittai Abraham, Jerusalem (IL)

Correspondence Address: WOODCOCK WASHBURN LLP (MICROSOFT CORPORATION), CIRA CENTRE, 12TH FLOOR, 2929 ARCH STREET, PHILADELPHIA, PA, 19104-2891, US

(73) Assignee: Microsoft Corporation, Redmond, WA (US)

(21) Appl. No.: 11/759,473

(22) Filed: Jun. 7, 2007

(51) Int. Cl. H04L 12/26

(52) U.S. Cl. 370/251

(57) ABSTRACT

A prediction tree for estimating values of a network performance measure. Leaf nodes of the prediction tree are associated with networked computing devices and interior nodes are not necessarily representative of physical network connections. Values are assigned to edges in the prediction tree and the network performance measure relative to two computing devices represented by two nodes of the tree is estimated by aggregating the values assigned to the edges in the path in the prediction tree joining the two edges. Mechanisms for adding nodes representing computing devices to the prediction tree, for identifying a closest node representing a computing device in the prediction tree, for identifying a cluster of devices represented by nodes of the tree, and for rebalancing the prediction tree are provided.

### BACKGROUND OF THE INVENTION

A computer network may comprise multiple computing devices interconnected by a communications system. Networking generally enables computers to do much more than communicate. Networked computers can share resources, including such things as: peripheral devices such as printers, disk drives, and routers; software applications; and data. Rapid growth in the use of computers and computer networks and the progression from mainframe computing to client-server applications and distributed computing have fueled interest in network performance optimization, network-aware applications and network modeling in general.

Network topology refers to the arrangement of the elements in a network, and especially the physical and logical interconnections between nodes of the network. Common basic network topologies include: a linear bus, in which nodes of the network are connected to a common communications backbone; a star, in which nodes are directly connected to a central hub node in a hub and spokes fashion; a ring, in which each node of the network is directly connected to two other nodes to form a ring; and a rooted tree, in which a root node is directly connected to one or more other nodes at a first level, each of which may be directly connected to one or more nodes at a next lower level, and so on. More generally, some pairs of nodes of a network may be may be directly connected to each other while other pairs of nodes may not be directly connected, forming a mesh.

The internet commonly refers to the collection of networks and gateways that utilize the TCP/IP suite of protocols, which are well-known in the art of computer networking. TCP/IP is an acronym for “Transmission Control Protocol/Internet Protocol.” The internet can be described as a system of geographically distributed remote computer networks interconnected by computers executing networking protocols that allow users to interact and share information over the network(s). Because of such wide-spread information sharing, remote networks such as the internet have thus far generally evolved into an open system for which developers can design software applications for performing specialized operations or services, essentially without restriction.

The internet network infrastructure enables a host of network topologies such as client/server, peer-to-peer, or hybrid architectures. The “client” is a member of a class or group that uses the services of another class or group to which it is not related. Thus, in computing, a client is a process, i.e., roughly a set of instructions or tasks, that requests a service provided by another program. The client process utilizes the requested service without having to “know” any working details about the other program or the service itself. In a client/server architecture, particularly a networked system, a client is usually a computer that accesses shared network resources provided by another computer, e.g., a server.

A server is typically a remote computer system accessible over a remote or local network, such as the internet. The client process may be active in a first computer system, and the server process may be active in a second computer system, communicating with one another over a communications medium, thus providing distributed functionality and allowing multiple clients to take advantage of the information-gathering capabilities of the server. Any software objects utilized pursuant to making use of the virtualized architecture(s) of the invention may be distributed across multiple computing devices or objects.

Client(s) and server(s) communicate with one another utilizing the functionality provided by protocol layer(s). For example, HyperText Transfer Protocol (HTTP) is a common protocol that is used in conjunction with the World Wide Web (WWW), or “the Web.” Typically, a computer network address such as an Internet Protocol (IP) address or other reference such as a Universal Resource Locator (URL) can be used to identify the server or client computers to each other. The network address can be referred to as a URL address. Communication can be provided over a communications medium, e.g., client(s) and server(s) may be coupled to one another via TCP/IP connection(s) for high-capacity communication.

Computer network models may be used to analyze, predict, or optimize network properties. Network tools can measure performance characteristics such as latency times between nodes of the network, bandwidths, traffic rates, error rates, and the like. Knowledge of such performance characteristics can be used to improve or enhance the functionality of network aware applications. Generally, determining such network performance characteristics has required computationally expensive and time consuming network communications.

### SUMMARY OF THE INVENTION

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

Methods and systems for modeling inter-nodal network performance parameters, such as latency, are described herein. A prediction tree is a virtual topology of a network, where virtual nodes connect real end hosts, and carefully computed edge weights model a network parameter, such as latency. Prediction trees may support several application-level functionalities such as closest-node discovery and locality-aware clustering without placing undue additional burdens on the network. Some applications, such as for example, content distribution networks, can benefit from the ability to estimate network latency between end hosts instantaneously, without incurring the overhead of recurrent measurements.

Mechanisms are described for constructing a virtual topology of the network that accurately represents latency between nodes. The described approach for modeling the internal structure of the network enables intrinsic support of functionalities such as latency prediction, closest node discovery, and proximity-based clustering with little additional network overhead. The virtual topology used to model the network is a tree. Although many networks are decidedly non-treelike, the prediction trees described herein provide robust models for estimating important network metrics. Mechanisms described herein maintain a collection of virtual trees between participating nodes and handle changes in network latencies, tolerate network and node failures, and scale well as new nodes join the system.

### BRIEF DESCRIPTION OF THE DRAWINGS

FIG. 1 is an idealized view of a computing network;

FIG. 2 is an example prediction tree;

FIG. 3 is an example of computing devices and inter-node latencies;

FIG. 4 is an example of a portion of a prediction tree corresponding to the example of FIG. 3;

FIG. 5 is an example of a prediction tree and a node to be joined to the prediction tree;

FIG. 6 is an example of the prediction tree of FIG. 5 with the node joined;

FIG. 7 is an example of a portion of a prediction tree;

FIG. 8 is a flow diagram for a method of discovering an approximate closest node in a prediction tree;

FIG. 9 is an example prediction tree and a device not represented in the tree;

FIG. 10 is a flow diagram for an embodiment of a protocol for joining a new leaf node to a prediction tree;

FIG. 11 is a flow diagram for another embodiment of a protocol for joining a new node to a prediction tree;

FIG. 12 is a flow diagram for an embodiment of a process of constructing a random prediction tree;

FIG. 13 is flow diagram for an embodiment of a process for determining an ordering of nodes to be added to a prediction tree; and

FIG. 14 is an example of a prediction tree before and after balancing.

### DETAILED DESCRIPTION OF ILLUSTRATIVE EMBODIMENTS

Certain specific details are set forth in the following description and figures to provide a thorough understanding of various embodiments of the invention. Certain well-known details often associated with computing and software technology are not set forth in the following disclosure to avoid unnecessarily obscuring the various embodiments. Further, those of ordinary skill in the relevant art will understand that they can practice other embodiments without one or more of the details described below. Finally, while various methods are described with reference to steps and sequences in the following disclosure, the description as such is for providing a clear implementation of embodiments of the invention, and the steps and sequences of steps should not be taken as required to practice this invention.

It should be understood that the various techniques described herein may be implemented in logic realized with hardware or software or, where appropriate, with a combination of both. Thus, the methods and apparatus, or certain aspects or portions thereof, may take the form of program code (e.g., instructions) embodied in tangible media, such as floppy diskettes, CD-ROMs, hard drives, or any other machine-readable storage medium wherein, when the program code is loaded into and executed by a machine, such as a computer, the machine becomes an apparatus for practicing the invention. In the case of program code execution on programmable computers, the computing device generally includes a processor, a storage medium readable by the processor (including volatile and non-volatile memory and/or storage elements), at least one input device, and at least one output device. One or more programs that may implement or utilize the processes described in connection with the invention, e.g., through the use of an API, reusable controls, or the like. Such programs are preferably implemented in a high level procedural or object oriented programming language to communicate with a computer system, or may be implemented in assembly or machine language, if desired. In any case, the language may be a compiled or interpreted language, and combined with hardware implementations.

Although exemplary embodiments may refer to using aspects of the invention in the context of one or more stand-alone computer systems, the invention is not so limited, but rather may be implemented in connection with any computing environment, such as a network or distributed computing environment. Still further, aspects of the invention may be implemented in or across a plurality of processing chips or devices, and storage may similarly be effected across a plurality of devices. Such devices might include personal computers, network servers, handheld devices, supercomputers, or computers integrated into other systems such as automobiles and airplanes.

Various methods and systems are described for constructing, modifying, maintaining, and using prediction trees to model inter-nodal network performance measures. An inter-nodal network performance measure describes some aspect of network performance as it relates to a pair of networked devices. Although the following discussion is focused on the use of prediction trees for modeling network latencies, it is contemplated that the methods and systems herein are applicable to other inter-nodal network performance measures, such as, by way of examples, loss rate, throughput, and available bandwidth.

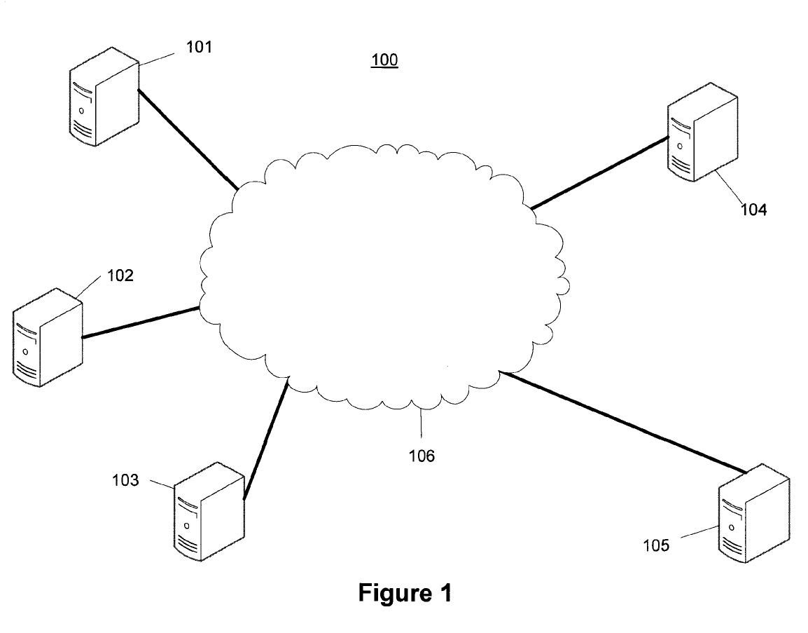

FIG. 1 depicts an idealized view of a computing network 100. Computing devices 101, 102, 103, 104, 105 are nodes on the network 100. The internal structure 106 of the network is depicted as a cloud to represent the fact that the internal structure 106 need not be known in detail and may generally comprise a possibly complicated snarl of, for example, switches, hubs, routers, communications links, and a wide variety of other devices. For some of the pairs of computing devices 101-105, path latencies may be known. For example, two devices may be able to ping each other by sending echo requests, listening for echo responses, and noting the round-trip time.

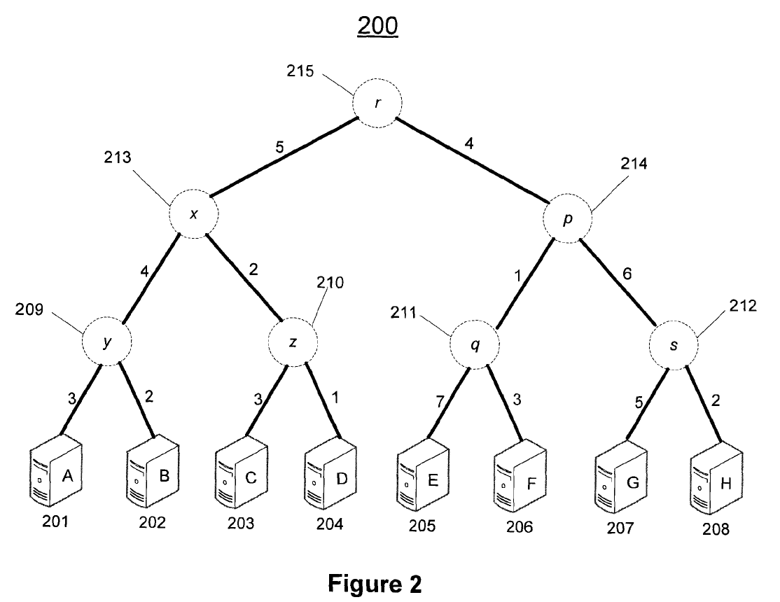

Known path latencies are used to construct a latency prediction tree in a manner that will be described below. FIG. 2 depicts an example of a latency prediction tree 200 for modeling path latencies in a network having eight computing devices, A-H, represented by eight leaf nodes 201-208. Interior tree nodes 209-215, labeled p, q, r, s, x, y, and z, are virtual nodes and do not represent physical network elements. Some nodes of the tree are joined by edges representing latency times between the nodes. In the example, the latency between computing device A represented by leaf node 201 and interior virtual node y 209 is 3, where any convenient units for latency, such as milliseconds, for example, may be used. For purposes of this discussion, the edge between computing device A and virtual node y is denoted Ay and we say that the length Ay is 3. In the example, the length By is 2, Cz is 3, Dz is 1, yx is 4, and so on. Lengths are symmetric. That is, the length Ax is the same as the length xA.

Using the example prediction tree 200, the latency between two leaf nodes is estimated by finding the total length of the edges in the path joining the two leaf nodes. For example, the latency between devices A 201 and B 202 is computed by finding the length of the path AyB, which is Ay plus yB or 3+2=5. As another example, the latency between E and G is estimated to be the length of the path EqpsG=Eq+qp+ps+sG=7+1+6+5=19. In this manner, the latency between any two leaf nodes in the tree, i.e., between any two computing devices on the network, may be estimated.

It is important to note that the interior nodes in the tree are virtual nodes which do not directly represent physical connections or devices. For example, in the prediction tree 200, the interior node y 209 does not indicate a physical device linking devices A 201 and B 202.

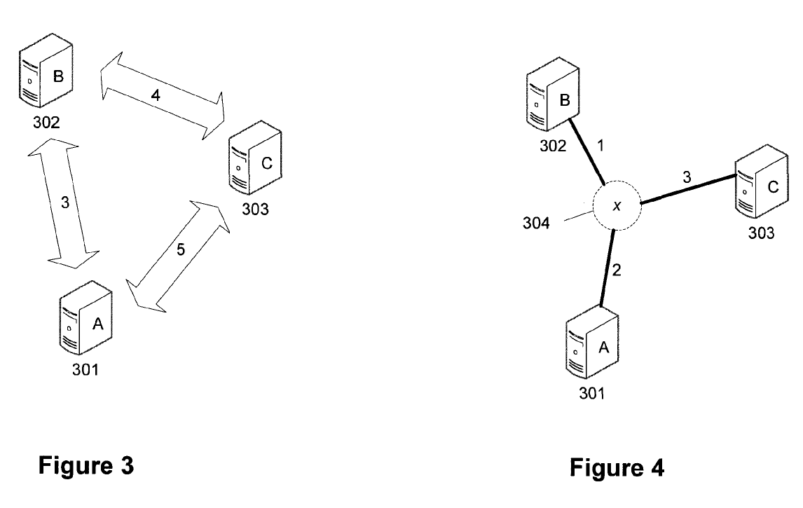

FIGS. 3 and 4 depicts an example of how a prediction tree may initially be constructed from measured inter-node latencies. FIG. 3 depicts a simple network having 3 computing devices, A 301, B 302, and C 303 with measured inter-node latencies: A to B=3, A to C=5, and B to C=4. To construct a prediction tree as shown in FIG. 4, a virtual interior node x 304 is added. Lengths are assigned to the links Ax, Bx, and Cx so as to make the path lengths consistent with the measured inter-node latencies of FIG. 3. That is, lengths are assigned so that Ax+xB=AxB=3, Ax+xC=AxC=5, and Bx+xC=BxC=4. The system of three equations in three unknowns, Ax, Bx, and Cx is readily solved algebraically:

Ax=(Ax+xB+Ax+xC−(Bx+xC))/2=(AxB+AxC−BxC)/2=(3+5−4)/2=2

Bx=(Bx+xA+Bx+xC−(Ax+xC))/2=(BxA+BxC−AxC)/2=(3+4−5)/2=1

Cx=(Cx+xA+Cx+xB−(Ax+xB))/2=(CxA+CxB−AxB)/2=(5+4−3)/2=3

thereby determining the lengths of the links between the leaf nodes (A 301, B 302, and C 303) and the added interior node (x 304).

Inter-node latencies can be determined from the prediction tree of FIG. 4. For example, the latency between device A 301 and C 303 may be determined by computing the total length of the path AxC=Ax+xC=2+3=5. Note that this value agrees with the measured inter-node latency between A 301 and C 303 used to construct the prediction tree.

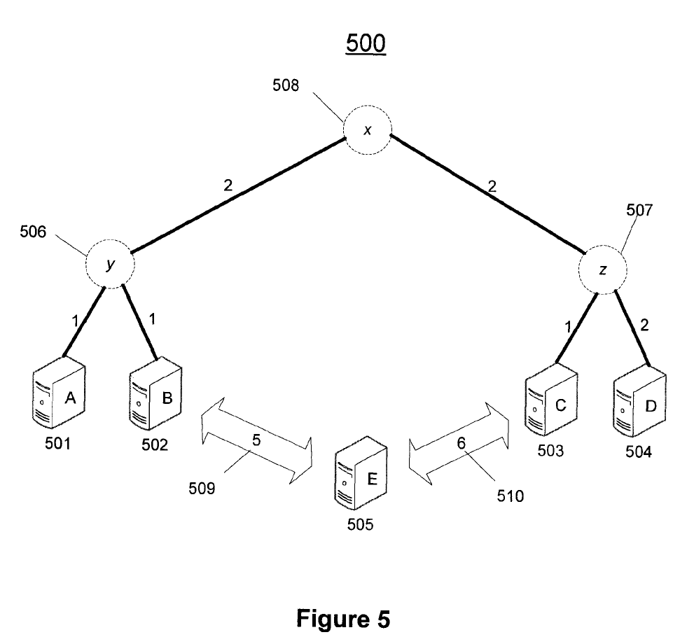

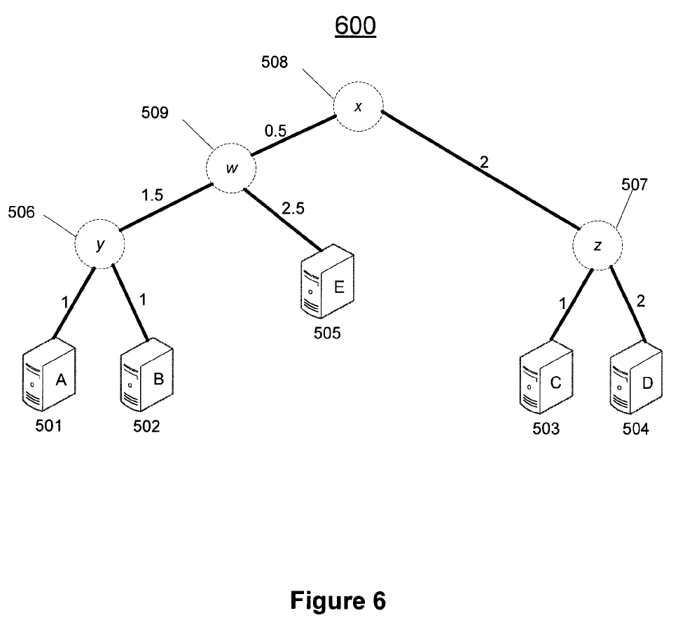

FIGS. 5 and 6 depict an example of adding a new leaf node, representing an added computing device, to an existing prediction tree. FIG. 5 depicts a prediction tree 500, comprising leaf nodes 501-504, representing computing devices A-D, and interior nodes 506-508. Lengths, representing latencies, are shown next to links connecting nodes of the tree. A node representing a new computing device is to be added to the prediction tree. A new interior node is to be added to the tree by splitting an edge between two existing nodes and inserting the new interior node which will be linked to a leaf node corresponding to the new computing device. Ideally, one would like to find the permutation of nodes that would produce the most accurate prediction tree given known latency values. In practice, examining all possible permutations may not be feasible, particularly in a distributed setting involving perhaps thousands of nodes. The following heuristic may be used to attach a new node E 505 to the existing prediction tree 500. As a first step, the existing leaf node closest to E 505 is identified. For example, a closest node discovery protocol, such as described below, could be used to locate an existing leaf node closest to E 505. In the example, B 502 has been identified as the closest leaf node and will be used as one “anchor” for attaching the new leaf node.

The immediate vicinity of the first anchor is searched for another leaf node to use as a second anchor. A new interior node is to be placed on the path between the two anchors. The second anchor is preferably chosen so as to minimize the distance between the new interior node and the newly added leaf node, although other processes for choosing a second anchor may be used. In the example, C 503 has been chosen as the second anchor. Knowing the triad of distances between the new leaf node and the two anchors, the distance from the new interior node to the new leaf node may be computed algebraically. If w denotes the new interior node to be added, E the new leaf node to be added, and B and C two anchor nodes for which the lengths (i.e. latencies) from E to B 509 and E to C 510 have been determined, then the length Ew can be computed algebraically as

Ew=((Ew+wB)+(Ew+wC)−(Bw+wC))/2=(EB+EC−BC)/2

In the example of FIG. 5, a new node w should be placed along the path between the anchor nodes B and C so that its distance from E is (EB+EC−BC)/2=(5+6−(1+2+2+1))/2=2.5. The point at which to insert the new interior node w may be determined by noting that Bw=BE−Ew=5−2.5=2.5. FIG. 6 depicts the new prediction tree 600 formed after nodes w 509 and E 505 have added to the prediction tree 500 of FIG. 5. The new prediction tree includes leaf nodes A-E, 501-505 and interior nodes 506-509. One may readily verify that the measured latencies BE=5 and CE=6 are faithfully represented in the new prediction tree 600. The new prediction tree 600 may be used to estimate unmeasured latencies. For example, the latency between E and D may be estimated by the length of the path EwxzD=2.5+0.5+2+2=7.

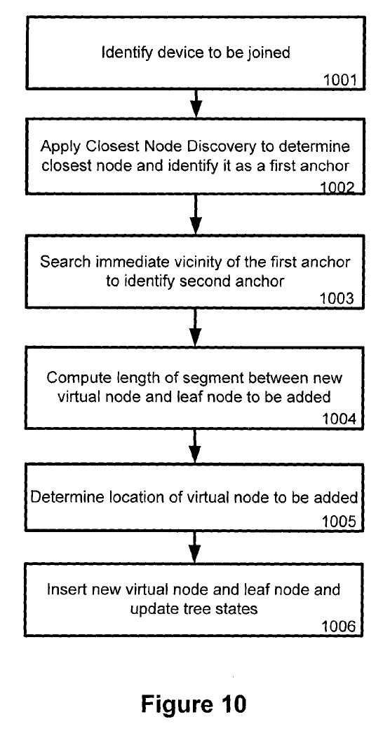

An embodiment of the join process is described by the flow chart of FIG. 10 and described in more detail below.

Implementation

The logical structure of a prediction tree may be stored in a distributed manner. Standard techniques for storing and maintaining a distributed hierarchy involve running a protocol between nodes and their parent and child nodes. Such techniques cannot be applied to prediction trees as described herein since interior nodes are virtual and do not represent physical machines that can send or receive messages. In one embodiment, the logical hierarchy representing the prediction tree is stored by having each physical leaf node store an ordered list of all of its ancestor virtual nodes along with their respective states. The state of any given virtual node consists of the identifiers of its parent and child nodes with their respective distances from the virtual node, and, for each virtual child node of the given virtual node, a list of representative leaf node descendants from the subtree descending from the child node, called “contacts.” Contacts are useful for facilitating communications relative to the nodes of the prediction tree, and are especially useful in recursive techniques such as described below. The list of representative leaf node descendants need not be a complete list and may, for example, be capped at some fixed number, say tc, of contacts, where tc is a protocol parameter.

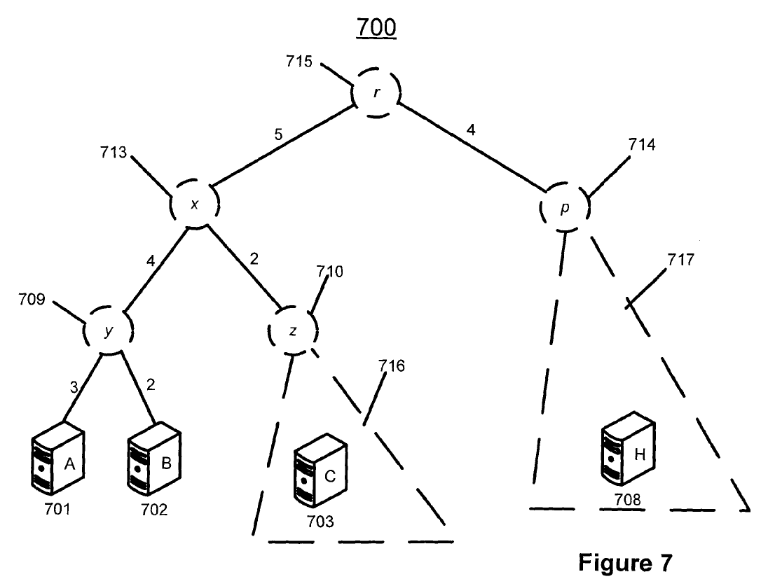

FIG. 7 shows a portion 700 of the example prediction tree 200 of FIG. 2. The shown portion includes leaf nodes (corresponding to computing devices) A 701, B 702, C 703, and H 708 and interior virtual nodes y 709, z 710, x 713, p 714, and r 715. Leaf node C 703 is representative of the subtree 716 descending from virtual node z 710. Leaf node H 708 is representative of the subtree 717 descending from virtual node p 714. In accordance with the description above, the state of interior virtual node x 713 might be state(x)=(parent, r, 5; child, y, 4, B; child, z, 2, C), where B and C are representative contacts from the subtrees descending from child nodes y and z, respectively, and the protocol parameter t is 1. The state of leaf node A 701 would include an ordered list of its ancestors and their states, as in state(A)=(y, state(y); x, state(x); w, state(w)).

The described embodiment is extremely robust since every physical leaf node stores the states of all of its virtual ancestor nodes. Should the physical network suffer a loss of a computing device, the prediction tree containing all of the nodes, both physical and virtual, for the remaining physical network remains intact.

The described embodiment is also exceptionally efficient. All communication from a virtual node to any of its ancestors can be emulated locally on any one of the virtual nodes physical descendants. For a physical node to emulate an interaction between a virtual ancestor and one of its virtual child nodes that is not an ancestor of the physical node, a message is sent to a contact of the virtual child node. For example, communication between virtual nodes y 709 and p 714 could be emulated by messages exchanged between physical node contacts A 701 and H 708. Physical node C 703 can reach destination node A 701 by sending a message to B 702 which is a contact for a child node, y 709, of Cs ancestor x 713. B then recursively forwards the message to the contact for a smaller subtree enclosing the destination node A 701.

Latency Estimation

Knowing the state of two physical leaf nodes the latency between the two associated computing devices to be estimated without the need for network communications or pings between the nodes. Each leaf node stores the state of all of its ancestors and the path from the leaf node to the root of the tree. For example, referring to the latency prediction tree 200 of FIG. 2, the latency between nodes A 201 and C 203 as follows. The state of A 201 includes an ordered list its ancestors: y, x, r. The state of C 203 includes an ordered list of its ancestors: z, x, r. The two lists of ancestors may be compared and a first common ancestor identified. In this example, the first common ancestor is x. Thus, the path in the prediction tree 200 from A 201 to C 203 runs from A 201 to x 213 to C 203. The path is AyxzC, consisting of the nodes A 201, y 209, x 213, z 210, and C 203. The lengths of the path edges are contained in the states of the virtual nodes which are stored in the physical leaf nodes as described above. For example, the state of y includes (parent, x, 4; child, A, 3; child, B, 2), from which the lengths Ay=3 and yx=4 may be determined. Continuing in this fashion, the length of AyxzC=3+4+2+3=12 is determined and the latency between A and C is estimated to be 12. Note that no actual measurement of the latency between the devices represented by A and C was required.

Closest Node Discovery

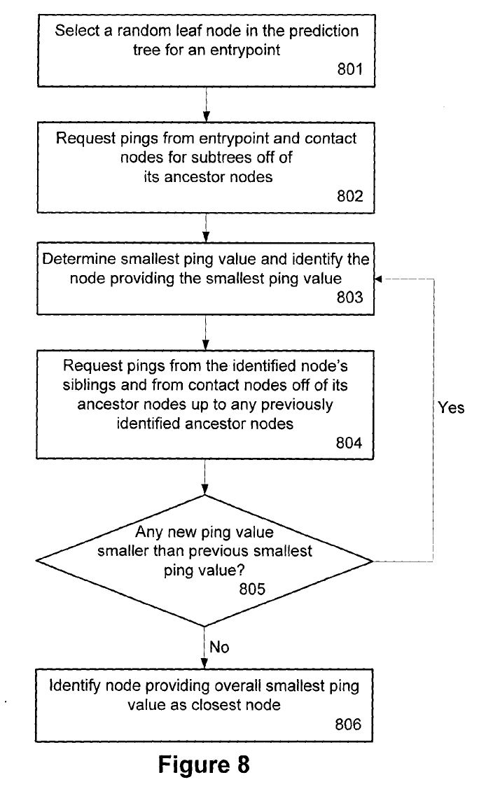

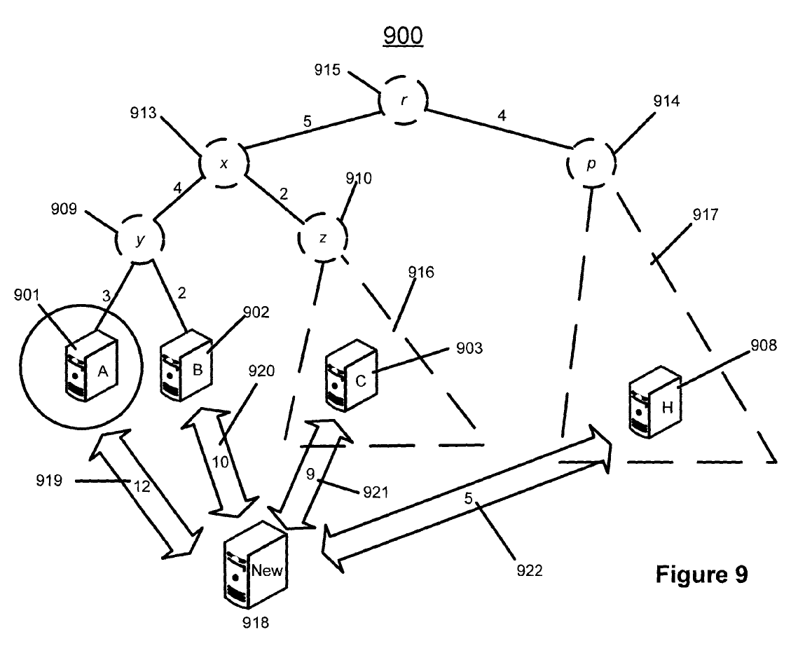

A prediction tree may be useful for identifying, at least approximately, which device represented by a leaf node of the prediction tree is optimal, in the sense of having the most favorable value of the inter-nodal network measure relative to a given target networked computing device that is not represented by a node of a prediction tree. For example, a latency prediction tree may be useful for identifying which device represented in the tree is approximately closest, in the sense of having a favorable inter-nodal latency, to a given target device not represented in the tree. FIG. 8 is a flow diagram for a method for discovering such an approximate closest node. First, a random leaf node of the tree, called the entrypoint, is selected 801 to start the process. The target device requests pings from the entrypoint device and from contact points for the subtrees off of each of the ancestor nodes of the entrypoint 802. The smallest of the ping values is determined and the node providing the smallest of the ping values is identified 803. The process is then repeated recursively, using the identified node as a new entrypoint. That is, pings are requested from the identified node's siblings and from contact nodes for the subtrees under the identified node's ancestors up to any previously identified ancestors 804. If any of the newly received ping values are smaller than the previously identified smallest ping value 805, then the process returns to step 804 and repeats. The search terminates when a new round of ping requests fails to return a smaller ping value than the smallest of the previous ping values and the “no” branch is taken from step 805. In another embodiment, the search may be terminated when an acceptably small ping value is received. The node providing the smallest ping value received is identified as the closest node 806.

An example of one stage of the process may be illustrated with reference to FIG. 9. Leaf node 901 has been selected as the entrypoint for a closest node discovery process for the latency prediction tree 900. New device 918, which is not represented by a node of the prediction tree 900, requests pings from the entrypoint 901, its sibling node 902, and from contact nodes for subtrees off of the entrypoint's ancestors, nodes y 909, x 913, and r 915. The subtree off of node y 909 is the entrypoint's sibling B 902. The subtree off of ancestor node x 913 is the subtree 916 descending from node z 910 which has C 903 as its contact. The subtree off of ancestor node r 915 is the subtree 917 descending from node p 914 which has H 908 as its contact. Thus, the new device 918 requests pings from A 901, B 902, C 903, and H 908. The ping values are indicated by the double arrows 919-922. The ping 922 from H 908 has the lowest value, and so the next stage of the process will operate with H 908 as an entrypoint for the process running on the subtree 917 rooted at p 914.

Note that the closest node discovery process described here is guaranteed to terminate since at each stage the process will either not find a new ping value smaller than previously found values or will proceed to a next stage operating on a prediction subtree having lesser height.

The closest node discovery process described above is not guaranteed to find the absolute closest node to the new device. To improve accuracy, the initial entrypoint contacted by the new device can execute multiple instances of the discover protocol in parallel, for example by selecting some number of random contact nodes from other subtrees and forwarding closest node discovery requests to them. By choosing the number of parallel requests, system overhead costs can be exchanged for greater accuracy.

Subtree Multicast

Prediction trees may be useful for multicast protocols allowing applications to disseminate data throughout the network represented by the prediction tree. A subtree multicast protocol uses a recursive approach to disseminate data within increasingly small subtrees in a manner similar to the approach described above for closest node discovery.

To multicast a message to a subtree containing a sending device, the sending device forwards the message to all physical child nodes of its ancestor nodes, and to contacts for each virtual child of its ancestor nodes. Each contact then recursively multicasts the message within the subtree for which it is the contact.

Locality Based Clustering

A cluster of physical devices near a given target device may be identified with the aid of a prediction tree. To obtain the neighbors of a virtual node, the target node device sends a message to a contact node for a subtree under that virtual node. The contact returns the state of the virtual node, from which the target node can extract its neighbors as well as contacts for the subtrees under those neighbors. Proceeding in this manner, clusters of a specified cardinality or of a specified latency radius around the target node can be identified.

Join Protocol

FIG. 10 is a flow diagram for an embodiment of a join protocol for adding a new device and leaf node to an existing prediction tree. An example of joining a new leaf node to a prediction tree was described above in connection with FIGS. 5 and 6.

A device to be represented by an added leaf node to a prediction tree is identified 1001. A closest node discovery protocol, such as, for example, described above, is applied to determine the node in the existing prediction tree closest to the device and the closest node is identified as a first anchor 1002. The immediate vicinity of the first anchor is searched and a second anchor is identified 1003. For example, nodes near the first anchor can be examined, and the node which will minimize the length of the edge from a new virtual node to be added, as described below, and the added leaf node which will descend from the new virtual node may be selected as the second anchor.

Once the two anchors are selected, the length of the edge between the new leaf node and the virtual node from which it descends is computed 1004, and the location for placing the new virtual node is determined 1005, for example as described above in connection with FIG. 5. The new virtual node and leaf node are inserted into the prediction tree and the tree states are updated 1006, for example via multicast as described above.

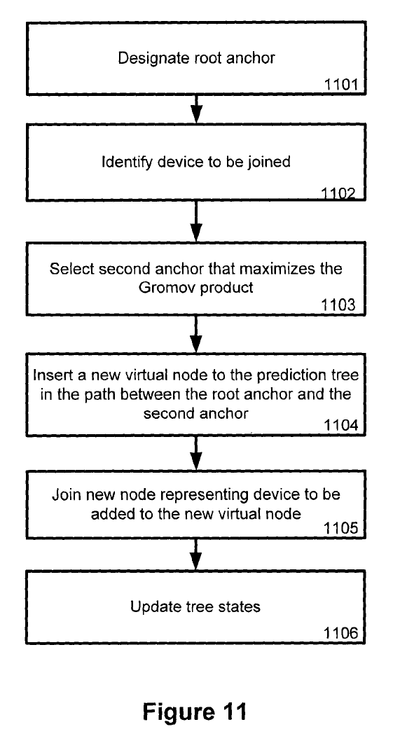

FIG. 11 is a flow diagram for another embodiment of a join protocol for adding a new device and leaf node to an existing prediction tree. It is convenient for purposes of the following description to define some terminology. Let d(a,b) denote the distance between nodes a and b in the prediction tree. It is desirable to have d(a,b) be equal to the value of the inter-nodal performance measure with respect to the nodes a and b. The Gromov product of nodes a and b with respect to node r is defined as

(a|b)r=½(d(r,a)+d(r,b)−d(a,b))

Note that, as discussed above with respect to FIGS. 3 and 4, if r is a root anchor node and a is a second anchor node, (a|b)r will be the distance from node r to a new virtual interior node added on the path between r and a through which node b may be joined to the prediction tree.

A particular leaf node is designated 1101 as a root anchor for the prediction tree. The root anchor node, r, will serve as one anchor for the addition of any new node to the prediction tree. A new device to be added to the tree is identified 1102 and associated with a new node b for the prediction tree. A second anchor node is selected 1103 as a leaf node a for which the Gromov product, (a|b)r, is maximum. Selecting the second anchor node a in this manner helps to insure minimal distortion between the determined internodal performance measures and the tree distances.

A new virtual node, s, is inserted in the tree 1104 in the path between r and a at a distance (a|b)r from r. The new node, b, representing the device to be added, is joined to s by a link of length d(r,b)−(a|b)r. The tree states are updated 1105 to reflect the new nodes and links, for example via multicast as described above.

Groves of Prediction Trees—Improving Accuracy

A latency prediction tree such as described herein provides estimate of latencies between physical nodes of a network. Accuracy can be improved by making use of a collection of prediction trees, called a grove, where each prediction tree constructed in a randomized way, adding nodes in a randomized manner, and has the same membership. Latency estimates may be obtained by selecting the median of latency estimates produced by each of the prediction trees in the collection.

A grove of prediction trees is maintained by simultaneously constructing a new tree while removing a tree, preferably the oldest tree, from the grove. Each node maintains its state for some stable set of trees along with an identifier of a growing tree.

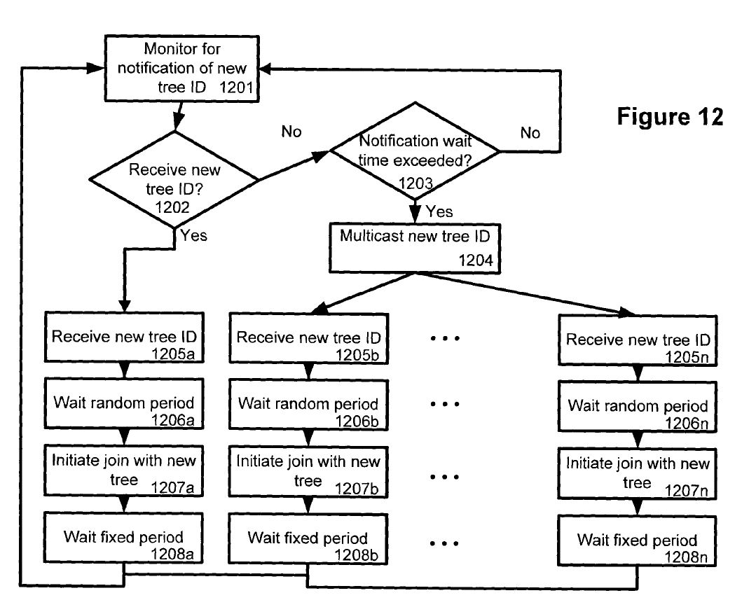

FIG. 12 is a flow diagram for an embodiment of a process of constructing a new, random prediction tree using physical nodes from an existing prediction tree. The process begins when no new prediction tree is currently being constructed. A device monitors for a notification of a new tree identifier 1201. If no such notification has been received, i.e., the “no” branch out of decision step 1202, the device checks whether a notification wait time has been exceeded 1203. If the notification wait time has not been exceeded, i.e., the “no” branch out of decision step 1203, the device resumes monitoring 1201. If instead, the device determines that the notification wait time has been exceeded, i.e., the “yes” branch out of decision step 1203, the device initiates the construction of a new, random prediction tree by multicasting a new tree identifier 1204. The multicast may be accomplished as described above, for example by using any existing prediction tree.

Upon receiving a new tree identifier 1205a, 1205b, 1205n each node waits for its own random period of time, 1206a, 1206b, 1206n respectively, and then initiates a join with the growing new prediction tree 1207a, 1207b, 1207n. The join may be performed, for example, as described above with respect to FIGS. 5, 6, and 10. Since each node waits its own random period of time, up to some maximum wait time tmax, before joining the growing prediction tree, the new tree will have had its nodes added in a random order, as desired.

Once a node has been joined to the new tree, it waits for a fixed period of time, 1208a, 1208b, 1208n, preferably some small multiple tmax, before deciding the new tree is stable. The nodes then return to the step of monitoring for a new tree identifier and the initiation of the next new random prediction tree creation.

In an alternative embodiment, a grove of prediction trees can be generated by first selecting a collection of nodes and then building a collection of prediction trees wherein each prediction tree in the grove uses a different one of the selected nodes as a fixed root anchor node for joining the remaining nodes to the prediction tree, as described above in relation to FIG. 11.

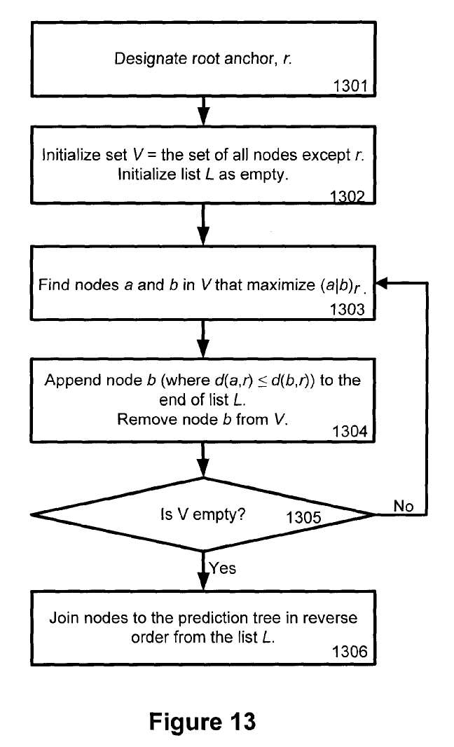

The order of joining new nodes to a prediction tree using a fixed root anchor node may be selected as depicted in FIG. 13. A root anchor node for the tree is designated 1301. A set of nodes, V, is initialized to contain all of the physical leaf nodes of the prediction tree except for the root anchor r, and a list of nodes, L, is initialized as empty 1302. The nodes in V are examined and the pair of nodes, a and b, that maximize (a|b)r is identified 1303. The node of the pair that is furthest from r is appended to the list L and removed from the set V 1304. If the set V is non-empty, the process repeats beginning at step 1303. Once the set V is empty, L will contain an ordered list of the nodes to be added to the prediction tree. The nodes from L are then joined to the tree, for example as described above in relation to FIG. 11, in reverse order, i.e., with the last node added to L joined first, and so on 1306.

As an alternative to the condition in step 1303, i.e., finding a and b to maximize (a|b)r, the following criteria can be used for selecting a node b for appending to the list L: Find a and b such that (a|b)r is maximal and (b|r)a/(a|r)b □ 1/1 or (b|r)a/(a|r)b<1 and nb □ na (where na and nb represent the number of nodes in the subtree rooted at the virtual node used to join a and b respectively to the tree), where 1 is a chosen parameter. A preferred value for 1 is 1=max{1+1/log N, (1+2ε)/(1−2ε)}, where N is the number of nodes, and ε is value for which d(w,z)+d(x,y)□ d(w,y)+d(y,z)+2ε min {d(w,x),d(y,z)}. Heuristically, this condition chooses a node that is either further from the root than a certain parameter or a node with fewer children, and should lead to a relatively more balanced prediction tree.

Handling Failures

In general, repairing a distributed tree structure can be difficult and computationally expensive. However, the structure of the prediction trees described herein helps to make recovery from failures relatively easy. Since physical nodes are present only at the leaves of the prediction tree, the failure of one device need not seriously impact the structure of the tree. Each remaining node stores state information for all of its ancestor virtual nodes. Each node that used the failed node as a contact for one of its enclosing subtrees can switch over to using one of its other contacts for that subtree, assuming that the number of contacts, tc is greater than one. The state of each virtual node is replicated at every physical node under it. Hence, a virtual node can “fail” only if all of its physical descendants fail, in which case the virtual node is no longer required and so no failure recovery is necessary.

Tree Balancing

Prediction trees constructed as described above might not be balanced in terms of height. Since a prediction tree is a logical hierarchy with leaf nodes storing the states of all of their ancestors, it may be generally desirable to periodically run a balancing protocol, moving the root node downward and elevating a child of the root to root status.

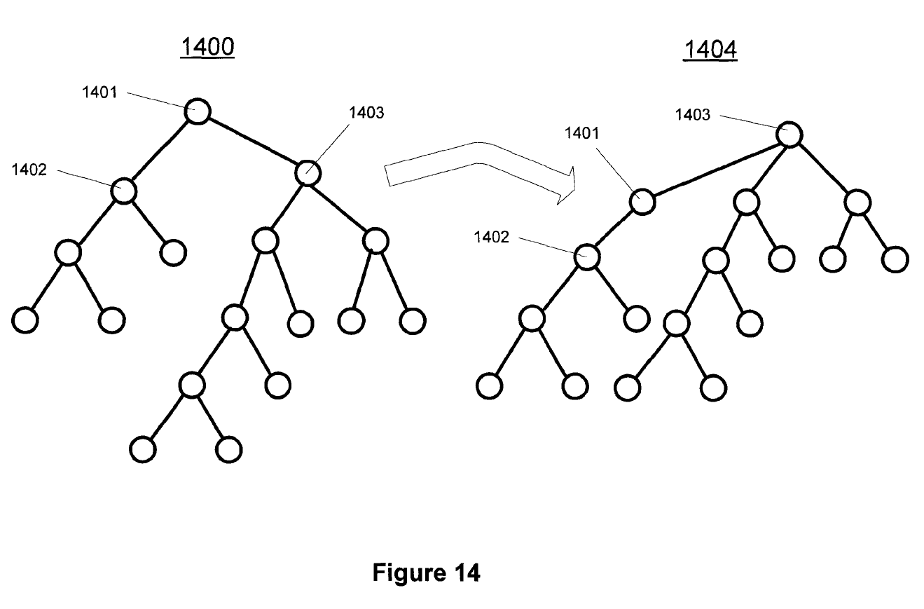

FIG. 14 depicts an example of tree balancing. The prediction tree 1400 on the left, having node 1401 as its root, is unbalanced. The subtree descending from node 1402 has height two. The subtree descending from node 1403 has height four. Whenever one subtree off of a child of the root has a height that is more than one greater than the height of all other subtrees off of child nodes of the root, the tree may be rebalanced by moving the root 1401 down one level and elevating the child node 1403 with the greatest subtree height to become the new root. The prediction tree 1404 on the right depicts the result of such rebalancing. Note that such a move does not modify the underlying structure of the tree and has no impact on prediction accuracy.

Rebalancing may be implemented first calculating the height of each first-level subtree directly under the root by aggregating height values up the tree recursively, perhaps in a manner similar to the multicast and closest node discovery protocols described above. For example, a node initiating the aggregation may send out messages to all of its contacts in its various subtrees which then recursively search their subtrees for the physical leaf node at the greatest depth from the root, replying to the starting node with that depth value. If a first-level subtree is found to be deeper than all other first-level subtrees by more than one level, the root is moved down and the node at the top of the deepest first level subtree is moved up to the root position. Although the move does not alter the underlying structure of the tree, it does involve a multicast to the entire tree to modify the states for the old and the new root nodes and to remove and add their states to the appropriate descendant physical nodes.

Applications

Awareness of network performance measures can provide significant benefits for various network applications. Taking advantage of a knowledge of performance characteristics between nodes of a network enables applications to provide heightened performance service to users, to isolate the impact of a network failure, and improve the scalability of a system. Topology-aware applications are becoming more pervasive. Web-based services and content distribution networks (CNDs) often redirect client requests to a relatively close, high capacity server. Network monitoring applications and directory services may seek to restrict queries to within a network locality. Some peer-to-peer systems and distributed hash tables (DHTs) prefer to select neighbors based on network latency. Online gaming systems can benefit from latency aware protocols including closest node discovery, locality based clustering, and subtree multicasting.

While the present disclosure has been described in connection with various embodiments, illustrated in the various figures, it is understood that similar aspects may be used or modifications and additions may be made to the described aspects of the disclosed embodiments for performing the same function of the present disclosure without deviating therefrom. Other equivalent mechanisms to the described aspects are also contemplated by the teachings herein. Therefore, the present disclosure should not be limited to any single aspect, but rather construed in breadth and scope in accordance with the appended claims.

What is claimed:

1. A method comprising: accessing a prediction tree, said prediction tree comprising:
nodes corresponding to networked computing devices;
virtual interior nodes; and
links joining some nodes, each link being associated with a value related to an inter-nodal network performance measure;
aggregating values associated with links between nodes of the prediction tree;
determining an estimated value for the inter-nodal network performance measure relative to two networked computing devices represented by nodes of the prediction tree.

2. A method as recited in claim 1, wherein aggregating values comprises summing values associated with links of a path in the prediction tree joining two nodes corresponding to networked devices.

3. A method as recited in claim 1, wherein data descriptive of nodes of the prediction tree is stored in a distributed manner at networked computed devices associated with nodes of the prediction tree.

4. A method as recited in claim 1, further comprising adding a node to the prediction tree, wherein the added node corresponds to a specific networked computing device not represented in the prediction tree, and wherein adding a node comprises:
selecting two nodes of the prediction tree, each selected node corresponding to a networked computing device;
inserting a new virtual node into a path in the prediction tree between the two selected nodes;
linking a new node corresponding to the specific networked computing device to the new virtual node; and
assigning values to links joining the new virtual node to neighboring nodes of the prediction tree consistent with measured values of the inter-nodal network performance measure.

5. A method as recited in claim 4, wherein selecting two nodes of the prediction tree comprises:
measuring values of the inter-nodal network performance measure between the specific networked computing device and networked computing devices represented by nodes of the prediction tree;
selecting as a first node a node of the prediction tree representing a networked computing device for which the measured value of the inter-nodal network performance measure between the specific networked computing device and networked computing device is optimal among the measured values.

6. A method as recited in claim 1, further comprising identifying a networked computing device represented by a node of the prediction tree for which the inter-nodal performance measure is approximately optimized relative to a particular computing device, wherein said identifying comprises:
selecting a node of the prediction tree corresponding to a networked computing device;
measuring values of the inter-nodal network performance measure between the particular computing device and networked computing devices represented by the selected node of the prediction tree and by nodes corresponding to networked computing devices in subtrees of child nodes of ancestor nodes of the selected node;
ascertaining which measured value is most optimal;
identifying the networked computing device associated with a node which produced the most optimal value; and
repeating the selecting, measuring, ascertaining, and identifying, said repeating being continued until a most optimal value determined in an ascertaining step fails to be more optimal than a previously ascertained most optimal value or until a value within a specified range is ascertained.

7. A method as recited in claim 1, further comprising identifying a cluster of networked computing devices based on estimated inter-nodal network performance measures relative to a specified networked computing device.

8. A method as recited in claim 1, wherein accessing a prediction tree further comprises accessing a plurality of prediction trees, the method further comprising applying a statistical analysis to a plurality of estimated values obtained from the plurality of prediction trees.

9. A computer readable medium comprising computer executable instructions, the instructions comprising instructions for:
accessing a prediction tree, said prediction tree comprising:
leaf nodes corresponding to physical devices;
virtual interior nodes; and
links joining some nodes, each link being associated with a value related to an inter-nodal performance measure;
aggregating values associated with links between nodes of the prediction tree;
determining an estimated value for the performance measure relative to two physical devices represented by leaf nodes of the prediction tree.

10. A computer readable medium as recited in claim 9, wherein the instructions further comprise instructions for adding a node to the prediction tree, wherein the added node corresponds to a specific networked computing device not represented in the prediction tree.

11. A computer readable medium as recited in claim 9, wherein the instructions further comprise instructions for identifying a networked computing device represented by a node of the prediction tree for which the inter-nodal performance measure is approximately optimized relative to a particular computing device not represented by a node of the prediction tree, wherein said identifying comprises:
designating the entire prediction tree for searching;
selecting an initial leaf node of the designated portion of the prediction tree and a collection of leaf nodes of the designated portion of the prediction tree representing subtrees rooted at child nodes of ancestors of the initial leaf node;
measuring values of the inter-nodal network performance measure between the particular computing device and networked computing devices represented by the selected leaf nodes of the prediction tree;
determining a most optimal value among the measured values;
identifying a networked computing device associated with a leaf node for which the most optimal value if obtained; and
repeating the selecting, measuring, determining, and identifying on a subtree containing the leaf node associated with the identified networked computing device.

12. A computer readable medium as recited in claim 9, wherein the instructions further comprise instructions for identifying a cluster of networked computing devices based on estimated inter-nodal network performance measures relative to a specified networked computing device.

13. A computer readable medium as recited in claim 9, wherein the instruction further comprise instructions for accessing a plurality of prediction trees.

14. A computer readable medium as recited in claim 9, wherein the instructions further comprise instructions for storing data associated with nodes of the prediction tree in a memory associated with a networked computing device associated with a leaf node of the prediction tree.

15. A system comprising: means for accessing a prediction tree, the prediction tree comprising:
nodes corresponding to networked computing devices;
virtual interior nodes; and
links joining some nodes, each link being associated with a value related to a network performance measure;
means for estimating the network performance measure by accessing the prediction tree.

16. A system as recited in claim 15, further comprising:
means for adding a node corresponding to a networked computing device to the prediction tree.

17. A system as recited in claim 15, further comprising:
means for identifying a networked computing device represented by a node of the prediction tree for which the inter-nodal performance measure is approximately optimized relative to a particular computing device not represented by a node of the prediction tree.

18. A system as recited in claim 15, further comprising:
means for identifying a cluster of networked computing devices based on estimated inter-nodal network performance measures relative to a specified networked computing device.

19. A system as recited in claim 15, further comprising:
memory means for storing data representative of nodes of the prediction tree, said memory means operationally connected to a networked computing device represented by a node of the prediction tree.

20. A system as recited in claim 19, further comprising:
means for designating a selected node of the prediction tree as a root of the prediction tree.
